(19) United States
(12) Patent Application Publication
(10) Pub. No.: US 2014/0036639 A1
(43) Pub. Date: Feb. 6, 2014

(54) FAMILY CALENDAR

(71) Applicants: Jalayne Taber BONI, Shoreline, WA (US); Janny WOO, Seattle, WA (US); Nathaniel Gardiner BROWN, Seattle, WA (US); Robert T. BUSACK, Seattle, WA (US); Derek Dalton CLARDY, Seattle, WA (US)

(72) Inventors: Jalayne Taber BONI, Shoreline, WA (US); Janny WOO, Seattle, WA (US); Nathaniel Gardiner BROWN, Seattle, WA (US); Robert T. BUSACK, Seattle, WA (US); Derek Dalton CLARDY, Seattle, WA (US)

(73) Assignee: COZI GROUP INC., Seattle, WA (US)

(21) Appl. No.: 13/565,689

(22) Filed: Aug. 2, 2012

(51) Int. Cl. G04G 9/00

(52) U.S. Cl. 368/29

(57) ABSTRACT

Disclosed is a calendar service which operates on multiple devices, including mobile devices and personal computers, which works with a server which can update or synchronize calendars across multiple 3^{rd} party calendar servers, which can change the amount of calendar data displayed depending on the zoom level of the display, which facilitates display of weekend days together, which can display a 2×2 grid of two days (horizontally) across two successive weeks (vertically), which 2×2 grid can be shifted up or down to traverse weeks or right or left to traverse days, which enables family members to quickly find and communicate free time, and which can display days in a week with a continuous vertical scroll.

### BACKGROUND INFORMATION

Services exist which use the iCalendar file format, X.400 protocols, CalDAV (RFC 4791) protocols, SyncML (a.k.a. “Open Mobile Alliance Data Synchronization and Device Management”) protocols, Microsoft Corporation's OUTLOOK®, MICROSOFT® EXCHANGE, and/or MICROSOFT® EXCHANGE SERVER formats or protocols to enable calendar software, which calendar software includes calendar views with year, month, week, and day views and which calendar software allows appointments, meetings, tasks, and reminders to be scheduled and which calendar software may be used to manage address books or contact lists. References herein to “calendar entries” and “calendar data” should be understood to comprise entries in a suitable file format for appointments, meetings, tasks, reminders, address books and contact lists. Such services can provide separate calendars for different people and can allow calendars for multiple people to be viewed through one interface.

Mobile and non-mobile computing devices exist which display information in pixels on a graphical display. Mobile and non-mobile computing devices now also exist which associate a matrix of contact sensors (responsive to styluses and/or human contact) with the graphical display to form a touchscreen. Mobile and non-mobile computing devices now also exist which associate a 2- or 3-dimensional physical space with a graphical display to form a motion-sensing input device, such as Microsoft, Inc.'s KINTECT® system. In combination with an appropriately configured operating system—such as Google, Inc.'s, ANDROID™, Apple Inc.'s iOS, Microsoft, Inc.'s WINDOWS® PHONE operating system, or Research In Motion's BLACKBERRY OS, or similar “desktop” operating systems which also enable touchscreen input—touchscreens correlate contact, including gestures and multi-touch gestures, with user input and user commands.

Calendar services, however, provide a bewildering array of configuration choices, can be difficult to use to manage calendars for members of a family, do not offer certain configuration options, can be difficult to use in constrained display environments as are often found on mobile devices, and do not provide certain touch-based user commands. In addition, such services do not change the amount of calendar data displayed depending on the zoom level of the display; nor do such services display weekend days together in response to a swipe command; nor do such services allow a week view to be shifted in a kinetic scroll by one or more days in response to a gesture command which travels up or down; nor do such services display a 2×2 grid of two days (horizontally) across two successive weeks (vertically), which 2×2 grid can be shifted up or down to traverse weeks or right or left to traverse days; nor do such services enable family members to quickly find and communicate free time; nor do such services display days in a week with a continuous vertical scroll.

Needed is a system which addresses the shortcomings discussed above.

### SUMMARY

Disclosed is a calendar service which operates on multiple devices, including mobile devices and personal computers, which works with a server which can synchronize, push or pull data between calendars across multiple 3^{rd} party calendar servers, which can change the amount of calendar data displayed depending on the zoom level of the display, which can display weekend days together, which allows a week view to be shifted by one week in response to a gesture command which travels from right to left or visa versa, which displays a 2×2 grid of two days (horizontally) across two successive weeks (vertically), which 2×2 grid can be shifted up or down to traverse weeks or right or left to traverse days, which enables family members to quickly find and communicate free time, and which can display days in a week with a continuous vertical scroll.

### BRIEF DESCRIPTION OF THE DRAWINGS

FIG. 1 is network and device diagram illustrating exemplary computing devices configured according to embodiments disclosed in this paper.

FIG. 2 is a flowchart illustrating an overview of a process in which a calendar management software application executes instructions according to embodiments disclosed in this paper.

FIG. 3 is a flowchart illustrating a detail of an alternative process which may be included in the process illustrated in FIG. 2.

FIG. 4 is a flowchart illustrating a detail of an alternative process which may be included in the process illustrated in FIG. 2.

FIG. 5 is a wireframe of an example of a “week view” user interface for a calendar management software application which is executing instructions according to embodiments disclosed in this paper.

FIG. 6 is a wireframe of an example of a “2×2” user interface for a calendar management software application which is executing instructions according to embodiments disclosed in this paper.

FIG. 7 is a wireframe of an example of a “2×2” user interface for a calendar management software application which is executing instructions according to embodiments disclosed in this paper.

FIG. 8 is a wireframe of an example of a “2×2” user interface for a calendar management software application which is executing instructions according to embodiments disclosed in this paper.

FIG. 9 is a wireframe of an example of a vertically oriented “month view” user interface for a calendar management software application which is executing instructions according to embodiments disclosed in this paper.

FIG. 10 is a wireframe of an example of a vertically oriented “month view” user interface for a calendar management software application which is executing instructions according to embodiments disclosed in this paper.

FIG. 11 is a wireframe of an example of a horizontally oriented “month view” user interface for a calendar application which is executing instructions according to embodiments disclosed in this paper.

FIG. 12 is a functional block diagram of exemplary computing devices and some data structures and/or components thereof.

FIG. 13 is a wireframe of an example of a vertically oriented “month view” user interface showing a “day view” list of appointments for a specific day in a calendar management software application further which is executing instructions according to embodiments disclosed in this paper.

FIG. 14 is a wireframe of an example of a “week view” user interface showing activation of a “Find free time” function in a calendar management software application which is executing instructions according to embodiments disclosed in this paper.

FIG. 15 is a wireframe of an example of “Find free time” and “Share free time” functions in a calendar management software application which is executing instructions according to embodiments disclosed in this paper.

FIG. 16 is a wireframe of an example of a “Find free time” function in a calendar management software application which is executing instructions according to embodiments disclosed in this paper.

FIG. 17 is a wireframe of an example of a “Find free time” function in a calendar management software application which is executing instructions according to embodiments disclosed in this paper.

FIG. 18 is a wireframe of an example of a “Find free time” function in a calendar management software application which is executing instructions according to embodiments disclosed in this paper.

FIG. 19 is a wireframe of an example of a “Collapse free time” function in a calendar management software application which is executing instructions according to embodiments disclosed in this paper.

### DETAILED DESCRIPTION

The following description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words in the above Detailed Description using the singular may also include the plural while words using the plural may also include the singular. The word “or,” in reference to a list of two or more items, covers all of the following interpretations of the word: any of the items in the list, all of the items in the list, and any combination of one or more of the items in the list.

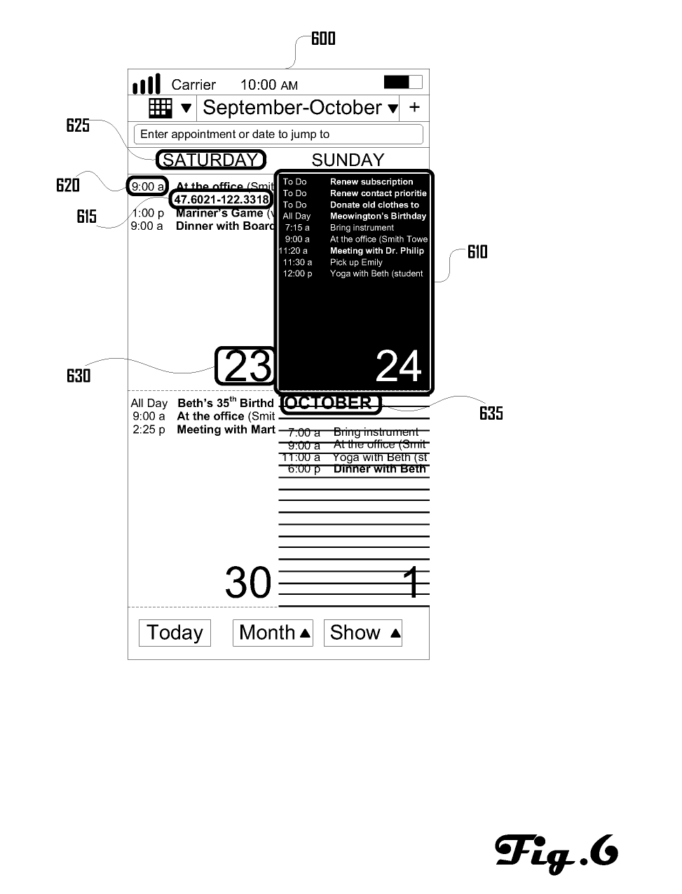

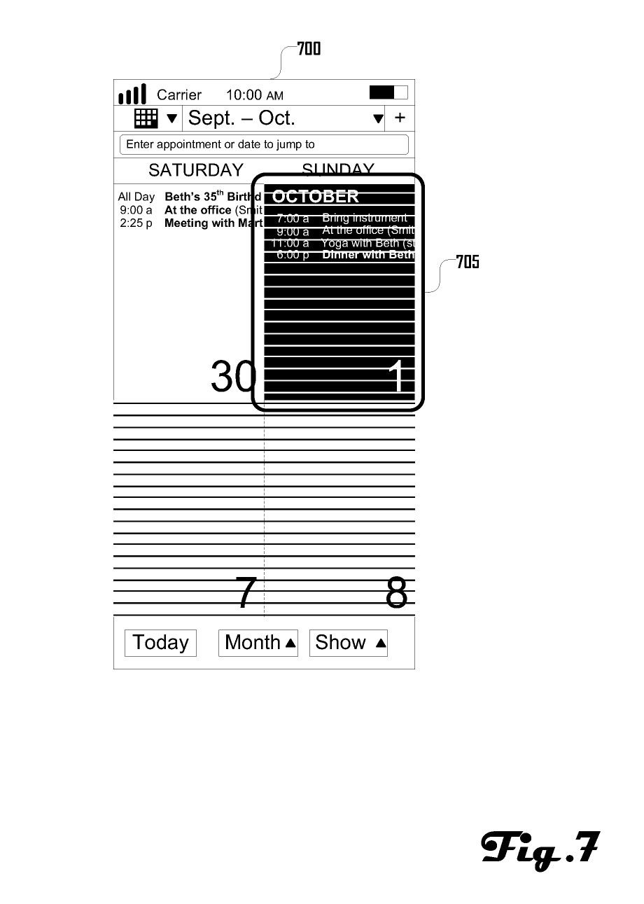

As used herein, “swipe” or means to contact a touchscreen and to move the contact left, right, up, or down (relative to the touchscreen user interface), which movement is interpreted by the touchscreen device's operating system as an instruction to scroll the rendered display in the opposite direction, relative to the movement. For example, a “swipe” to the left is interpreted by the touchscreen device's operating system as instruction to scroll the rendered display to the right. See, for example, FIGS. 6 and 7 (discussed elsewhere in greater detail), showing a 2×2 grid which has been swiped up between FIGS. 6 and 7, which up-swipe has scrolled the rendered display down. As used herein, “scroll” means to translate the visible portion of an image in an electronic display up, down, right, or left (or some combination thereof). Scrolling may occur in response to user input; user input may comprise user keyboard input, user interaction with a graphical control object (such as a mouse-controlled icon clicking on a scroll button), or a swipe. Scrolling may be smooth or continuous; scrolling may be discontinuous and may “jump” or “snap to” a display position (similar to a “page up” or “page down” command); scrolling may be punctuated, wherein a scroll may be continuous for a period, but may then be discontinuous. A “kinetic scroll” is a scroll is a continuous scroll which gives the appearance that the image has mass, momentum, and is subject to friction which slows the scroll rate.

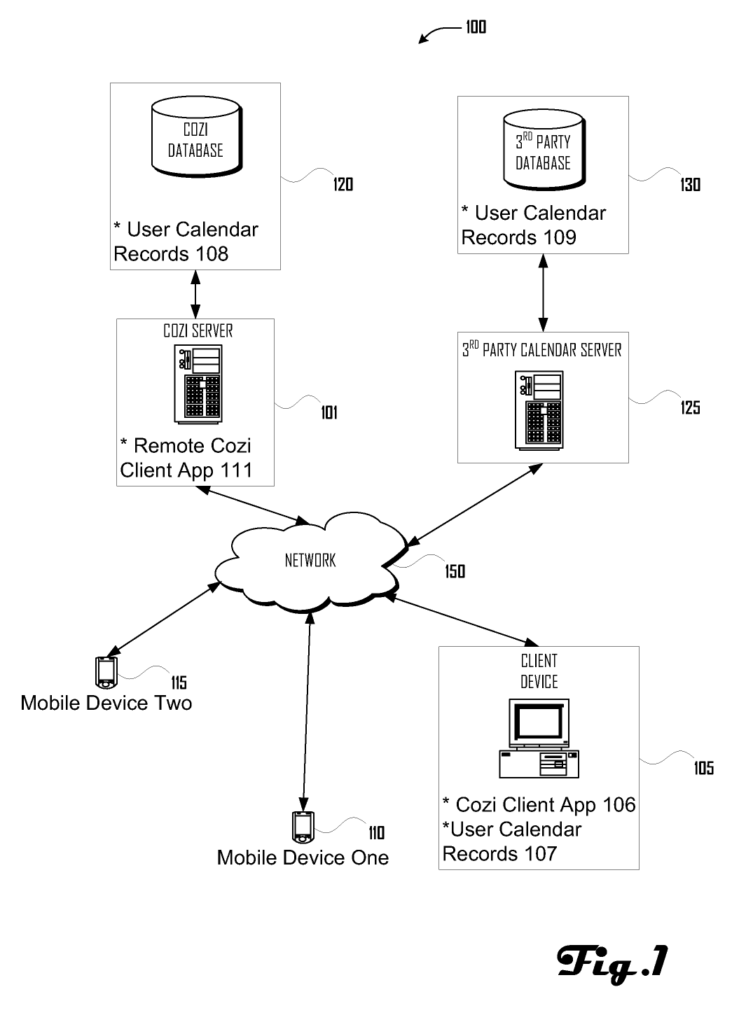

FIG. 1 is network and device diagram illustrating exemplary computing devices configured according to embodiments disclosed in this paper. In FIG. 1, a Cozi Server 101 is connected to a Network 150, such as the Internet; the Cozi Server 101 is illustrated as being connected to a Cozi Database 120. FIG. 1 also illustrates a 3^{rd} Party Calendar Server 125 as being connected to the Network 150; the 3^{rd} Party Calendar Server 125 is illustrated as being connected to a 3^{rd} Party Database 130. This paper discusses components as connecting to the Cozi Server 101 or to the 3^{rd} Party Calendar Server 125 or to a database connected to one of such components; it should be understood that such connections may be to, through, or via the other of the two connected components (a statement that a computing device connects with or sends data to the Cozi Server 101 should be understood as saying that the computing device may connect with or send data to the Cozi Server 101 and/or the Cozi Database 120). Although illustrated as separate components, the servers and databases may be provided by common (or separate) physical hardware and common (or separate) logic processors and memory components.

The Cozi Server 101 may maintain a database, such as the Cozi Database 120, containing calendar data for users of the Cozi Server 101, such as User Calendar Records 108. The Cozi Server 101 may connect with one or more 3^{rd} Party Calendar Servers 125 to provide calendar data to, obtain calendar data from and/or to synchronize calendar data between the Cozi Server 101 and the 3^{rd} Party Calendar Server 125 (or to synchronize calendar data between two or more 3^{rd} Party Calendar Servers 125).

Users of the Cozi Server 101 may be required to create an account with the Cozi Server 101, such as, for example, by providing login credentials (such as username and password). In a database, such as the Cozi Database 120, a user account may be associated with a GUID or other identifier which may be associated with calendar records associated with the user, including the user's login credentials. Calendar records associated with a user may comprise fields (or equivalent) which include authorizing credentials for accessing, obtaining, creating new, editing, and deleting calendar entries at 3^{rd} Party Calendar Server 125. Calendar records associated with a first user may comprise fields which contain references to, identifiers for, and/or credentials for second and third, etc., users, such that a calendar provided by the Cozi Server 101 for a first user may include views of calendar entries for the second, third, etc., users (a “user group”). A first user may have one or more of the following authorizations relative to a second, third, etc. user (with respect to calendars at the Cozi Server 101 or with respect to calendars at 3^{rd} Party Calendar Servers 125): authorization to access, obtain (view), create new, edit, and delete calendar entries. An example of user calendar records in the 3^{rd} Party Database 130 is provided by User Calendar Records 109. Users of the Cozi Service 101 may be able to access, view, create new, edit, and delete entries in calendars locally (without network access and without access to the Cozi Server 101), such as in User Calendar Records 107, which local changes are propagated to the Cozi Server 101, to the User Calendar Records 108, and/or to the 3^{rd} Party Database 130 and the User Calendar Records 109 when the user obtains network access.

Users of the Cozi Server 101 may connect to the Cozi Server 101 and via or from a client device, such as Client Device 105, Mobile Device One 110, and Mobile Device Two 115. Mobile Device One 110 and Mobile Device Two 115 are examples of client devices, such as Client Device 105. All of the client devices shown herein may comprise a touchscreen interface in addition to or instead of keyboard, mouse, trackball, stylus, voice and other input modes. References herein to any of the client devices should be understood to be interchangeable, except where specifically identified otherwise.

Connection to the Cozi Server 101 from a client device may be through a web browsing application and/or through the Cozi Client App 106 (which may use a web browsing application as an interface). Login credentials and a local instances of user calendar records, such as User Calendar Records 107, may be stored in or be accessible to the client device (such records may be stored remotely, at the Cozi Database 120, the 3^{rd} Party Database 130, or elsewhere). The Cozi Client App 106 may be stored and executed remotely relative to the client device, with the user provided access via application virtualization, such as remote terminal services, and/or, for example, through a web browser. An example of this is shown in FIG. 1 with the Remote Cozi Client App 111. Logging into the client device and/or the Cozi Client App 106 may provide access to User Calendar Records 107. Initiating execution of the Cozi Client App 106 or the Remote Cozi Client App 111 (which should be understood to include executing the Cozi Client App 106 or Remote Cozi Client App 111 through application virtualization or through a browser) provides the user with access to the calendar service disclosed herein. Hereinafter, references to the Cozi Client App 106 shall be understood to include the Remote Cozi Client App 111, unless the context makes clear otherwise.

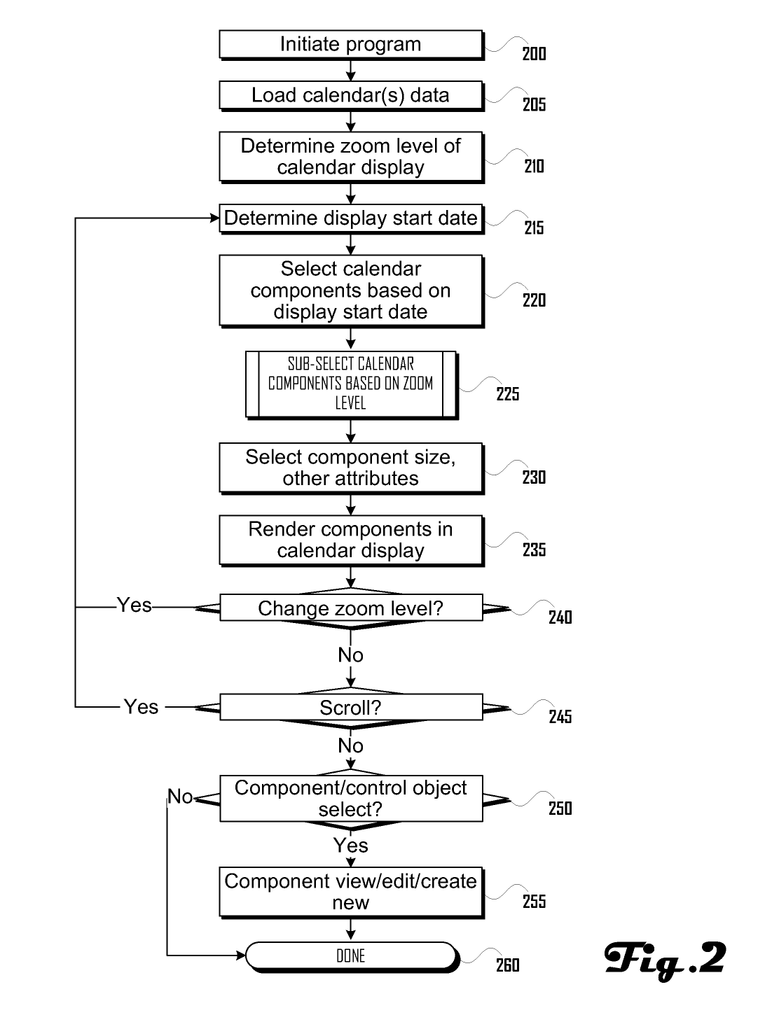

FIG. 2 is a flowchart illustrating an overview of a process in which a calendar management software application executes instructions according to embodiments disclosed in this paper. The calendar management software application is the Cozi Client App 106. At step 200, the Cozi Client App 106 is initiated, which may include logging in and providing credentials, as discussed above. At step 205, a first user's calendar data is loaded. The first user's calendar data, such as User Calendar Records 107, may include second user's calendar data, accessed as discussed above. When loaded, the calendar data may be incorporated into a calendar display user interface presented to the user, as discussed further herein. At step 210 a zoom level of the calendar display is determined. A “zoom level” is defined herein as a format for displaying calendar data in a grid; zoom levels comprise a year view, a month view, a 2×2 view, a week view, and a day view, all of which are defined further herein. Determination of the zoom level may be according to a default setting, such as a “month view;” a default setting may also be the last setting before the Cozi Client App 106 was last terminated.

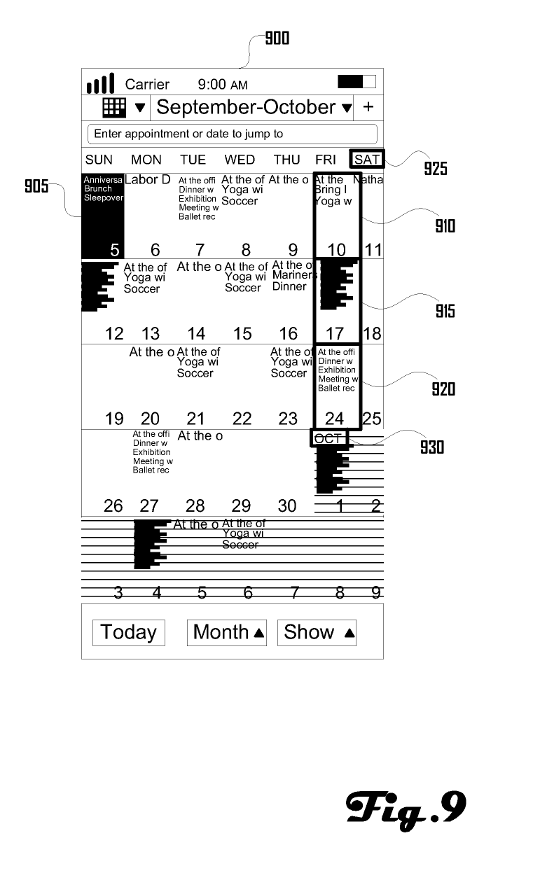

At step 215, a display start date is determined. “Display start date” is defined herein as the first date in the determined or selected zoom level grid, starting at the top left-hand corner of the zoom level grid. The start date is not necessarily the “currently selected date.” The currently selected date is the date or date-time selected by the user or by the Cozi Client App 106. An example of a currently selected date is element 610 in FIG. 6, element 705 in FIG. 7, and element 905 in FIG. 9, which elements are illustrated with a black background. The currently selected date may be, for example, “today” (relative to the then-current date) or another date selected by the user. The display start date may be determined by default (by the Cozi Client App 106) to be a Saturday and/or the user may be allowed to scroll the view to start or finish with a Saturday-Sunday block, which scroll may accomplished by a swipe. Typically, software calendar applications place Monday through Friday in the middle of a display grid, with Saturday on the left and Sunday on the right or with Saturday and Sunday not showing. For families managing a calendar, the weekends may be the most significant days to manage and it may be more convenient to have Saturday and Sunday displayed next to one another. For examples and further discussion of placing Saturday as the display start date, see FIGS. 6, 7, and 8 and the corresponding portions of this paper which discuss these figures.

At step 220, the calendar components are selected from the first user's calendar data, such as from the User Calendar Records 107. The calendar components are defined herein to comprise, for example, the following: year, month-text (such as, “September” or “Sep”), month-number (such as, “7” or “07” for the month of July), day-number (such as, “26”), day-of-week-text (such as, “Thursday”), appointment text, start time, end time, notes, location, and a representation of a person. The calendar components defined herein are examples of calendar components. The RFC 2445 (the iCalendar Request for Comments published by The Internet Society in 1998) and similar protocols define calendar components. The calendar components defined herein may comprise more than one or a subset of a component in RFC 2445 and similar protocols; the calendar components defined herein may comprise a transformation of a calendar component defined in a protocol, such as a transformation of a numerical calendar day into the corresponding text for the day of the week (based on the month and year in which the day occurs) or the transformation of a numerical month into the corresponding text for the month, or they may be new components not described in RFC 2445 or similar, such as “representation of a person.” A “location” may comprise fields for an address and/or latitude and longitude, or similar. A representation of a person may be text and/or a graphic; a color may be assigned to or selected for the representation of a person or to a background which surrounds or is otherwise associated with the representation of a person. The graphic in the representation of a person may be, for example, an image, a photograph, a sequence of images (an animation), a sequence of photographs (a video). The image may be a circle, oval, square, triangle or other shape. Calendar components may be graphical control objects within the calendar display, such that selection of or other user interaction with the control object may cause an action or software routine to be executed by the client device. Selection of calendar components is based on the display start date determined at step 215, with the selected calendar components comprising the calendar components which begin on the display start date and end on the last day shown in the zoom level grid.

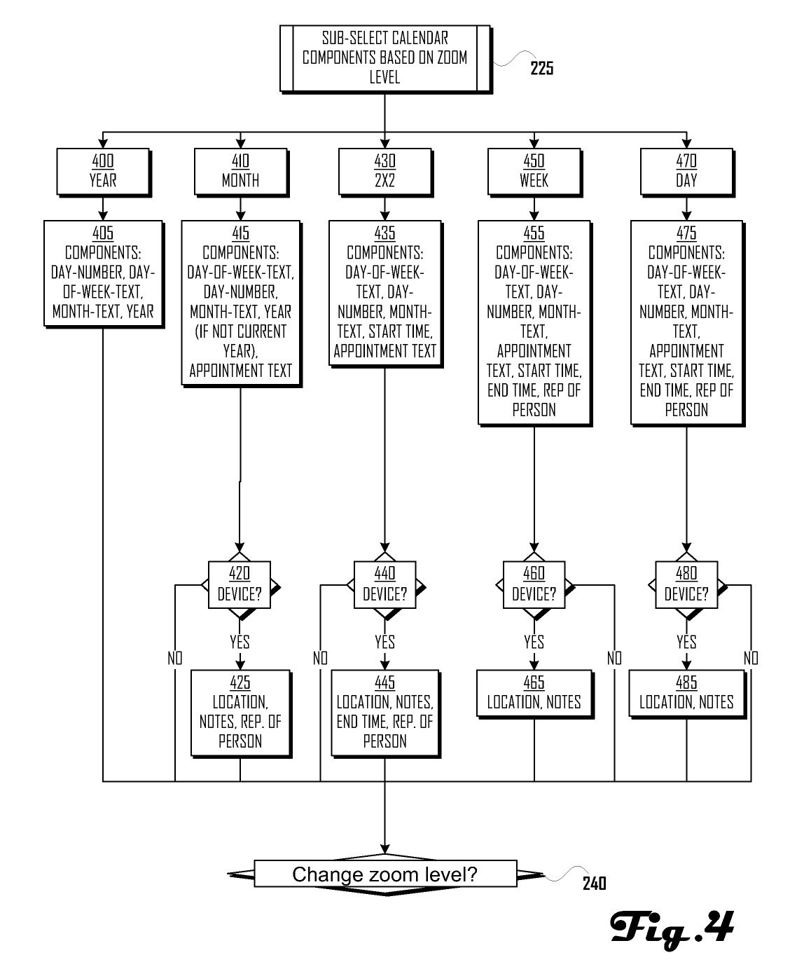

At step 225, the calendar components selected in step 220 are sub-selected based on the zoom level determined at step 210. This step may be combined with step 215, rather than occurring as a discrete step, as illustrated in FIG. 2. This process is discussed in greater detail in relation to FIG. 4.

At step 230 the size of the selected components may be determined. For example, if the number of components for display in a sector of the zoom level grid exceeds a threshold, then the size of selected components to be displayed in the sector may be reduced. For example, if a selected component comprises text, the font size may be reduced if the number of the selected components within a displayed sector exceeds a threshold. As an example, if a sector contains 1-3 appointments, the font size for the appointment text may be 9 points; if a sector contains 3-5 appointments, the font size for the appointment text may be 7 points; if a sector contains 6-7 appointments, the font size for the appointment text may be 5 points; if a sector contains 8-9 appointments, the font size for the appointment text may be 3 points; and if a sector contains 10-12 appointments, the font size for the appointment text may be 3 points. The smaller fonts may render the appointment text unreadable, but the user nonetheless can tell that there are a large number of appointments on the day in question. An example of the outcome of this process is shown at element 610 in FIG. 6, wherein the font size of the appointment text and of the start time components is smaller in the sector circled in element 610, day-number “24,” than in the sectors for neighboring days. An example is also shown in FIG. 9, elements 910, 915, and 920, wherein element 910 shows the largest font size and the fewest number of appointments, element 915 shows the smallest font size and the largest number of appointments, and element 920 shows an intermediate number of appointments and an intermediate font size. Though the examples are limited to fonts, the process may also apply to non-font components, such as a representation for a person. Other attributes which may be selected at this step include a font for text, a font kerning, a letter-spacing or tracking, and a leading of lines (for separate lines of components within the calendar display).

At step 235, the selected components at the selected size are rendered in the display for the client device at the determined zoom level. If a display had previously been rendered, such as during an iteration of steps 215 through 240 or 245, then this step may involve a “snap to” rendering, which does not involve rendering intermediate graphics or it may involve rendering intermediate graphics to give the appearance of motion, such as to give the appearance of a continuous scroll, a kinetic scroll, or a punctuated scroll. Rendering of intermediate graphics to give the appearance of motion may utilize functions of the underlying operating system for the client device.

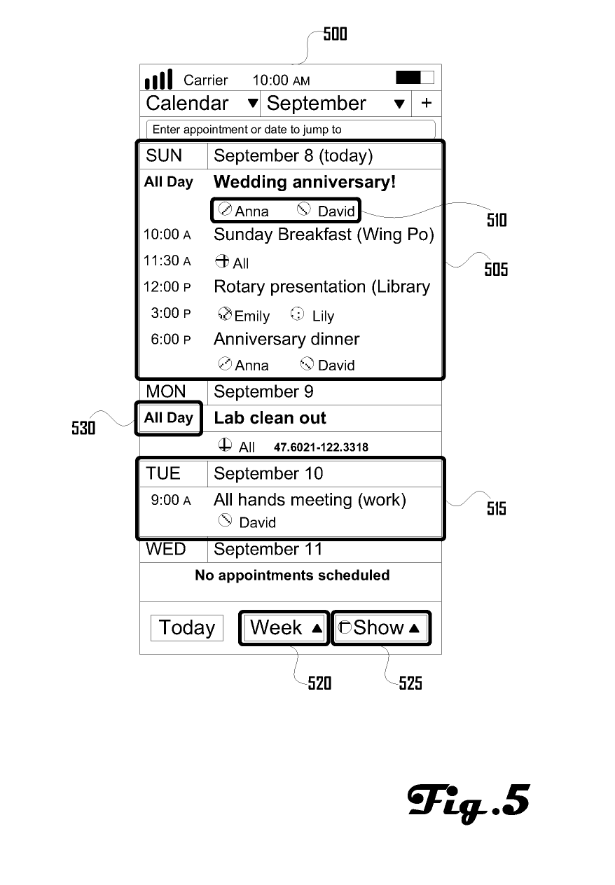

At step 240, a determination may be made regarding whether the zoom level of the calendar display has been changed. Such a determination may be based, for example, on receiving an instruction from the user through an input device associated with or part of the client device, such as optional input 1070. The input device may be a touchscreen, a keyboard, a mouse, a trackpad, a microphone, or a motion-sensing input device. The instruction may comprise a menu navigation or selection of a graphical control object. A graphical control object allowing menu navigation is shown as element 520 in FIG. 5 (with similar elements illustrated in other of the drawings). Selection of the graphical control object may open a selection list from which the user may select another zoom level. If the input device is a touchscreen, then the instruction to change the zoom level may be, for example, one of a one-finger gesture on the touchscreen, a two-finger gesture on the touchscreen, a multi-touch gesture on the touchscreen, a single tap, a long tap, and a double tap. Pinching or spreading two fingers is an example of a two-finger or multi-touch gesture on a touchscreen which may be interpreted as an instruction to change the zoom level. A pinch may be interpreted as an instruction to change to a zoom level which shows more days while a spread may be interpreted as an instruction to change to a zoom level which shows fewer days. The touchscreen instruction may associate a date at the center of a multi-touch gesture, at the start or end of a gesture, or a currently selected date with the instruction. If an instruction to change the zoom level was received, then the process may return to step 215 to determine the (revised) display start date. The process may then proceed through the steps discussed above.

If no instruction to change the zoom level was detected at step 240, then at step 245 a decision may be made regarding whether an instruction is received to scroll the display. As with step 240, such a determination may be based, for example, on receiving an instruction from the user through an input device associated with or part of the client device, such as optional input 1070. The input device may be a touchscreen, a keyboard, a mouse, a trackpad, a microphone, or a motion sensing input device. See the discussion of step 240 regarding the ways the instruction may be conveyed to, through, or by the client device. A swipe is example of an instruction to scroll the display. If an instruction to scroll the display was received, then the process may return to step 215 to determine the (revised) display start date. The process may then proceed through the steps discussed above.

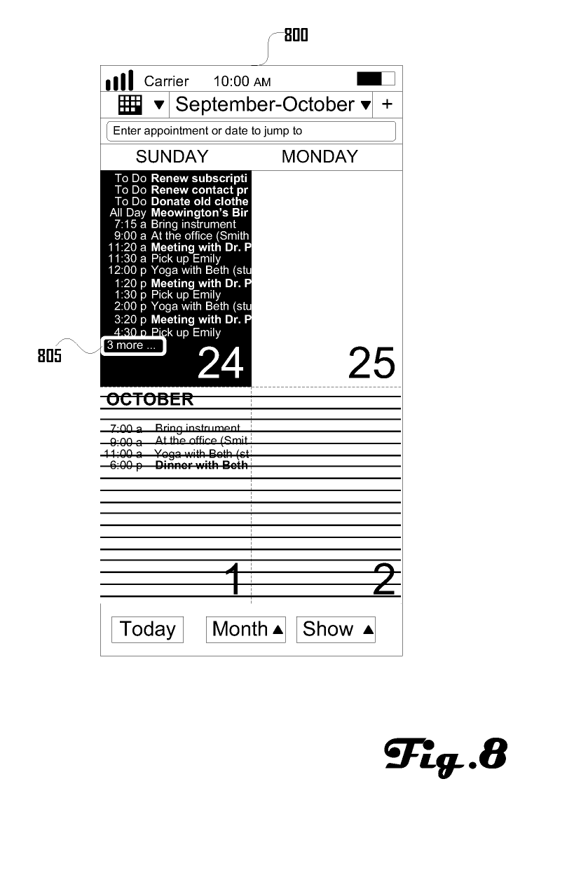

If no scroll instruction was detected at step 245, then at step 250 a determination may be made regarding whether an instruction is received to select a component or another graphical control object, such as a selection of control object which allows the user to change the number of user calendars displayed in the interface (see, for example, element 525 in FIG. 5 which, when selected, may show a selectable list of users and user group, such as “all,” whose calendar data is or may be displayed) or which displays to the user a “week view” of appointments (discussed further below). Selection of a component or graphical control object may also include, for example, selection of an appointment, selection of a day, selection of an ellipse or a number associated with an ellipse (see, for example, element 805 in FIG. 8), or selection of a representation of a person. If no such instruction is received, then the process may proceed to step 260, which, while labeled as “done,” may include monitoring for instructions to change the zoom level, monitoring for instructions to scroll the display, and/or monitoring for instructions to view, edit, or create a new component.

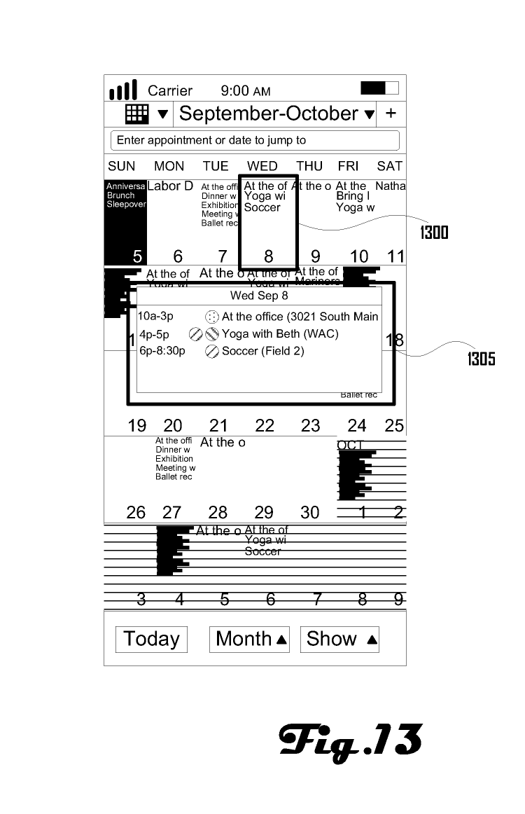

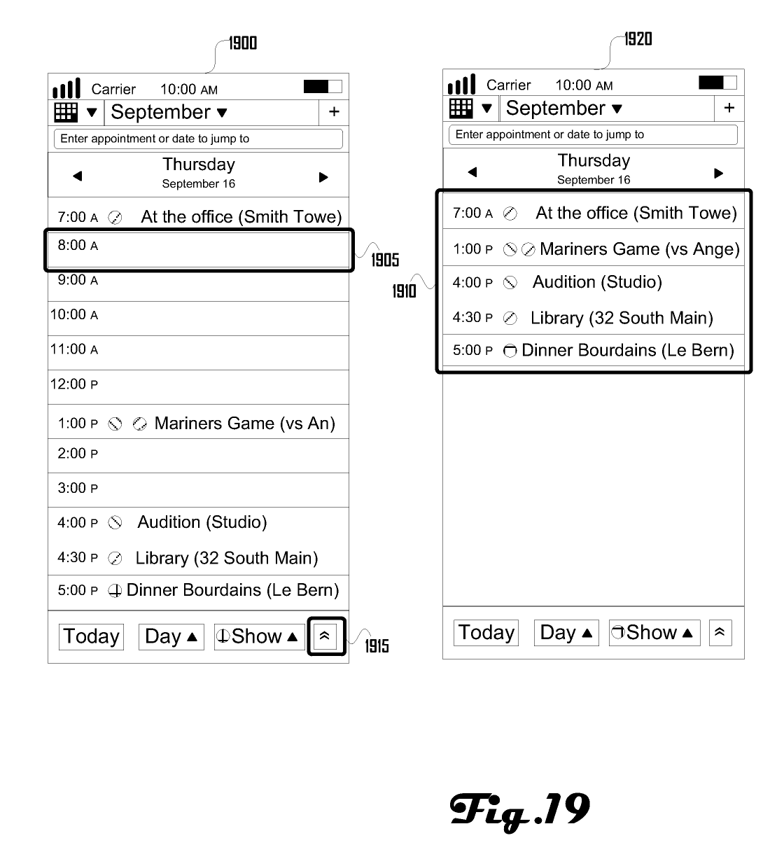

If, at step 250, an instruction to select one or more components was detected, then at step 255 a window, screen, or view may be displayed to allow the component or set of components to be viewed in greater detail, to allow the parameters of a component to be viewed and edited (an appointment comprising, for example, parameters for the text of the appointment, for the start and finish times, for alarms or notifications associated with the appointment) and to allow a new component to be created. See, for example, element 1305 in FIG. 13, which shows a day view comprising appointments in a day, which day view may be displayed after, for example, user selection (such as by a long press) of element 1300. Selection of one of the appointments in element 1305 may produce another window showing additional details relating to the selected appointment and allowing editing of the selected appointment. An alternative day view is shown as element 1900 in FIG. 19. The process may then proceed to step 260, discussed above.

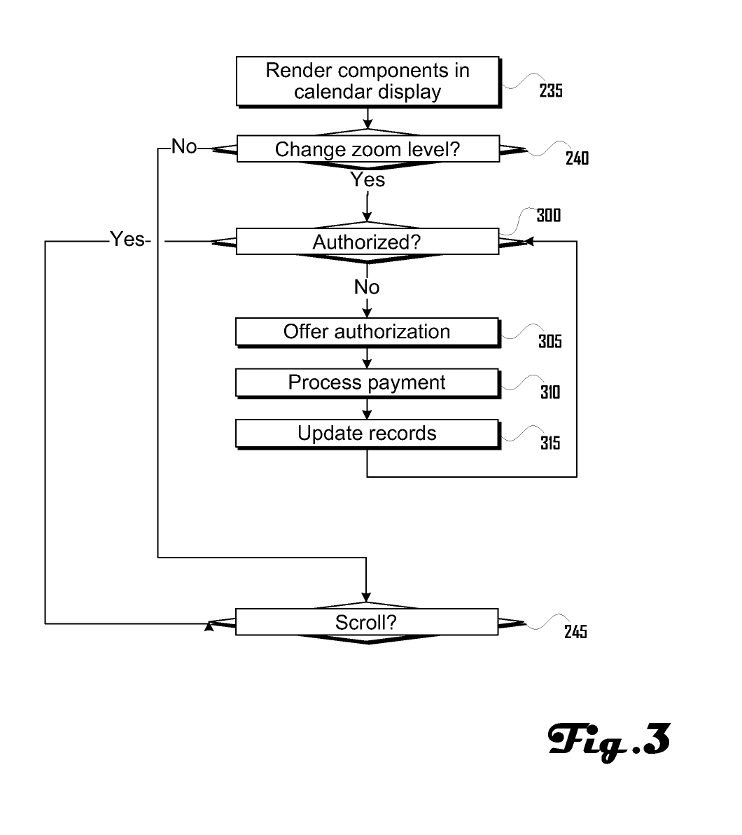

FIG. 3 is a flowchart illustrating a detail of an alternative process which may be included in the process illustrated in FIG. 2. At step 300, which is illustrated as following step 240 in FIG. 2, a determination may be made regarding whether the change in zoom level is authorized. For example, a user may be required to have a paid subscription, to have a paid subscription of a specified level, to otherwise pay consideration, or to meet certain criteria (such as an account with the Cozi Server 101 which has aged a certain amount, or with which the user interacts with a certain amount, or has made a certain number of referrals which resulted in new Cozi user accounts, or has mentioned or otherwise promoted Cozi in social networks) before the user is allowed to access different zoom levels. For example, changing to a 2×2 zoom level may require a “gold” subscription level, which subscription level requires that the user pay a monthly or yearly subscription fee. Determining if the change in zoom level is authorized may involve authenticating and authorizing the user against user records such as User Calendar Records 107 or 108, either at the Cozi Database 120 and/or at the Client Device 105.

If the change in zoom level is authorized (or authorization is not required), then the process may proceed to step 245 (discussed above). If the change in zoom level is not authorized, then at step 305 a window, screen, or similar may displayed with an offer to authorize the user to utilize the zoom level, provided the user meets the criteria. Step 305 may involve a determination regarding whether the user accepts the offer (if the user does not accept the offer, then the process may proceed to step 245). If the user has accepted the offer, then the process may proceed to step 310, where the payment (or receipt of other consideration) is processed. At step 315, the records, such as the User Calendar Records 107 or 108, are updated. The process may the proceed to step 215 or, as illustrated, back to step 300, where the updated user records may be checked, as discussed above.

FIG. 4 is a flowchart illustrating a detail of an alternative process which may be included in the process illustrated in FIG. 2. This illustration is an example of how calendar components may be sub-selected based on the zoom level; other components may be selected in steps 405, 415, 435, 455, and 475 (the components shown are examples). If the zoom level at step 210 was a year view, then the process proceeds to step 400; if the zoom level at step 210 was a month view, then the process proceeds to step 410; if the zoom level at step 210 was a 2×2 view, then the process proceeds to step 430; if the zoom level at step 210 was a week view, then the process proceeds to step 450; if the zoom level at step 210 was a day view, then the process proceeds to step 470.

At step 400, the zoom level is a year view. At step 405 the day-number, day-of-week-text, month-text, and year components are selected (the day-of-week-text may be abbreviated and displayed in relation to columns). The process then proceeds to step 240.

At step 410, the zoom level is a month view. At step 415 the day-of-week-text, day-number, month-text (which may be abbreviated), year (if it is not the current year), start time, and appointment text components are selected. At step 420 a determination may be made regarding whether the user's client device (such as Client Device 105, Mobile Device One 110, or Mobile Device Two 115) includes sufficient screen space to allow the inclusion of additional components. If yes, then at step 425, additional components, for example, location, notes, and representation of a person may be selected. If no, then the process may proceed to step 240.

In these steps, determination of sufficient screen space may be based on the type of device, on the device's screen size, number of pixels in a sector of the zoom level display, or similar.

At step 430, the zoom level is a 2×2 view. At step 435 the day-of-week-text, day-number, month-text, start time, and appointment text. At step 440 a determination may be made regarding whether the user's client device (such as Client Device 105, Mobile Device One 110, or Mobile Device Two 115) includes sufficient screen space to allow the inclusion of additional components. If yes, then at step 445, additional components, for example, location, notes, and end time may be selected. If no, then the process may proceed to step 240.

At step 450, the zoom level is a week view. At step 455 the day-of-week-text (which may be abbreviated), day-number, month-text (which may be abbreviated), appointment text, start time, end time, and representation of a person are selected. At step 460 a determination may be made regarding whether the user's client device (such as Client Device 105, Mobile Device One 110, or Mobile Device Two 115) includes sufficient screen space to allow the inclusion of additional components. If yes, then at step 465, additional components, for example, location and notes may be selected. If no, then the process may proceed to step 240.

At step 470, the zoom level is a day view for a specific day (which may also be described as an appointment list view for a single day). At step 475 the day-of-week-text (which may be abbreviated), day-number, month-text (which may be abbreviated), appointment text, start time, end time, and representation of a person are selected. At step 480 a determination may be made regarding whether the user's client device (such as Client Device 105, Mobile Device One 110, or Mobile Device Two 115) includes sufficient screen space to allow the inclusion of additional components. If yes, then at step 485, additional components, for example, location and notes may be selected. If no, then the process may proceed to step 240.

The process may then proceed to step 240.

FIG. 5 is a wireframe of an example of a “week view” user interface for a calendar management software application which is executing instructions according to embodiments disclosed in this paper. In this illustration, a grid is shown, which grid, shown in element 505, comprises one column for one day and at least one row, which one row is sub-divided into sub-rows for each successive appointment in the day. The one column includes (at the top) components for an abbreviation of the day-of-week-text, the month-text, and the day-number, and the numeric date arranged in sub-columns. The sub-rows may or may not have visible dividers between the sub-columns and sub-rows (the illustration includes a visible divider between the first sub-column containing the abbreviation for the day-of-week-text, but does not include visible dividers between the sub-rows). The sub-rows begin with a start time component; for all day events, the start time component may say, “All Day,” as shown in element 530. Element 510 shows two representations of a person, in this case for “Anna” and “David,” each of which include both text of the person's first name and a circle. A representation for a person for all people may include a circle and the word, “All.” The circles have different hash lines, indicating that they may have different colors. As discussed above, the color (or a different color) may also be used to color the text of the person's first name or highlighting behind the person's first name. Element 515 illustrates that additional rows for additional days may be shown as space allows in the display of client device. The week view may be scrolled up or down to show additional sub-rows (if the sub-rows for one day do not all fit in the display of the client device) or to show additional rows for subsequent days. The week view may be scrolled right or left to show preceding or subsequent weeks. Element 520 shows a graphical control object which may be selected by the user to direct the calendar management software application to show a different zoom level. The display start date selected following selection of a different zoom level may be determined to show a month, week, or day unit which includes the currently selected day. Element 525 shows a graphical control object which may be selected by the user to direct the calendar management software application to show a different user or user group or to show free time or to not show free time (discussed further below). Elements similar to 520 and 525 may be available in other of the zoom levels.

FIG. 6 is a wireframe of an example of a “2×2” user interface for a calendar management software application which is executing instructions according to embodiments disclosed in this paper. As discussed above, the 2×2 view is important because it allows Saturday and Sunday to be viewed in isolation from the rest of a week. As illustrated in FIG. 6, the 2×2 view comprises a grid with two columns, each column for a day, and two rows, one row for successive weeks. The columns have titles, in this example populated with components for the day-of-week-text (which may be abbreviated) (such as element 625). The intersection of a column and a row form a sector in the grid. The sectors are illustrated as being populated with components, such as, for example start times (element 620), appointment text, location (element 615, in this example, a latitude and longitude location), day-number (element 630), and month (element 635). The sector in which element 635 appears is depicted with cross-hatching (to represent a different color), because the month changes from the 30^{th} to the 1^{st}. As discussed above, a currently selected day is shown as element 610.

FIG. 7 is a wireframe of an example of a “2×2” user interface for a calendar management software application which is executing instructions according to embodiments disclosed in this paper. This Figure shows the result of swiping the 2×2 view of FIG. 6 up (or scrolling the 2×2 view of FIG. 6 down).

FIG. 8 is a wireframe of an example of a “2×2” user interface for a calendar management software application which is executing instructions according to embodiments disclosed in this paper. This Figure shows the result of swiping the 2×2 view of FIG. 6 left (or scrolling the 2×2 view of FIG. 6 right). As discussed above, this Figure also shows “3 more” followed by ellipses in element 805 (discussed above), which shows that there are three more appointments which did not fit into the sector. The “3 more . . . ” in element 805 may be selected via a long tap or a press above or below the “3 more . . . ” to open a popup view of the appointments listed for the day.

FIG. 9 is a wireframe of an example of a vertically oriented “month view” user interface for a calendar management software application which is executing instructions according to embodiments disclosed in this paper. As illustrated in FIG. 9, the month view comprises a grid with seven columns, one column for each day in a week, and five rows, one row for each successive week. The columns have titles, in this example populated with components for the day (such as element 925). The intersection of a column and a row form a sector in the grid. The sectors are illustrated as being populated with components, such as, for example, appointment text (in different font sizes, discussed above in relation to elements 905, 910, 915, and 920), and month-text (which may be abbreviated) (such as element 930). The sector in which element 930 appears (and subsequent sectors) is depicted with cross-hatching (representing a different color), because the month changes from the 30^{th} to the 1^{st}. As discussed above, a currently selected day is shown as element 905. When the month view is displayed, if an instruction to change the zoom level is detected, such as at step 240 of FIG. 2, which instruction is, for example, a multi-finger gesture on a specific day within the month view (such as a spread) or a double tap or a long tap on the specific day within the month view, then the instruction may be interpreted as an instruction to change to a 2×2 view and wherein the iteration of step 215, discussed above in relation to FIG. 2, will determine the second starting display date based on the specific day within the month view.

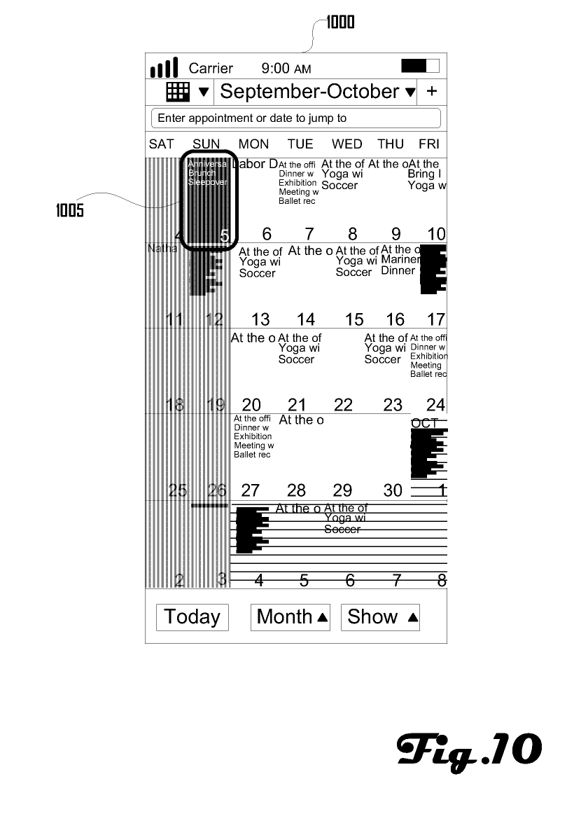

FIG. 10 is a wireframe of an example of a vertically oriented “month view” user interface for a calendar management software application which is executing instructions according to embodiments disclosed in this paper. In this Figure, Saturday and Sunday are in the two left-most columns. This view is obtained, for example, by swiping to the right once anywhere within the month view area in FIG. 9. Swiping to the left once anywhere within the month view area in FIG. 9 produces a view in which Saturday and Sunday are in the two right-most columns. Swiping to the right or left is an instruction to scroll the interface and to determine a display start date with Saturday and Sunday configured as noted immediately above. This is one of several unique features disclosed herein as, discussed above, other known calendars do not display Saturday and Sunday together and do not provide this convenient way to direct that Saturday and Sunday are to be displayed together when they are not. Swiping up or down within the month view area directs the interface to show succeeding (for example, in the case of a swipe up) or proceeding weeks. The “SAT” and “SUN” columns in FIG. 10 are shown with cross-hatching to indicate a different color, to distinguish the weekend from the weekday days.

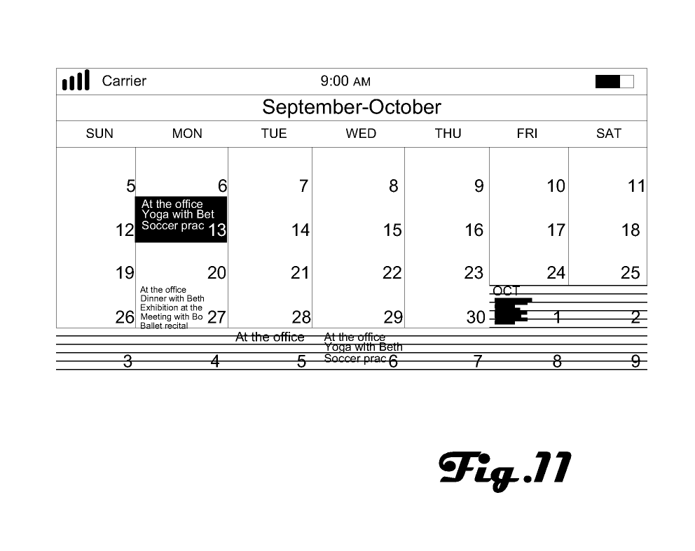

FIG. 11 is a wireframe of an example of a horizontally oriented “month view” user interface for a calendar management software application which is executing instructions according to embodiments disclosed in this paper.

FIG. 12 is a functional block diagram of exemplary computing devices and some data structures and/or components thereof, such as the computing devices shown in FIG. 1. In some embodiments, the computing device 1000 may include many more components than those shown in FIG. 10. However, it is not necessary that all of these generally conventional components be shown in order to disclose an illustrative embodiment. As shown in FIG. 10, the computing device 1000 includes a network interface 103 for connecting to the network 150.

The computing device 1200 also includes at least one processing unit 1210, memory 1250, and an optional display 1240, all interconnected along with the network interface 1230 via a bus 1220. The memory 1250 generally comprises a random access memory (“RAM”), a read only memory (“ROM”), and a permanent mass storage device, such as a disk drive or SDRAM (synchronous dynamic random-access memory). The memory 1250 stores program code for routines 1260, such as, for example, the Cozi Client App 106, as well as web browsing applications, web serving applications, and database applications. In addition, the memory 1250 also stores an operating system 1255. These software components may be loaded from a non-transient computer readable storage medium 1295 into memory 1250 of the computing device 1200 using a drive mechanism (not shown) associated with a non-transient computer readable storage medium 1295, such as a floppy disc, tape, DVD/CD-ROM drive, memory card, or other like storage medium. In some embodiments, software components may also or instead be loaded via a mechanism other than a drive mechanism and computer readable storage medium 1295 (e.g., via network interface 1230).

The computing device 1200 may also comprise hardware supporting optional input modalities, Optional Input 1270, such as, for example, a touchscreen, a keyboard, a mouse, a trackball, a stylus, a microphone, and a camera.

Computing device 1200 also comprises or communicates via bus 1220 with workflow data store 1265. In various embodiments, bus 1220 may comprise a storage area network (“SAN”), a high speed serial bus, and/or via other suitable communication technology. In some embodiments, computing device 1200 may communicate with workflow data store 1265 via network interface 1230.

FIG. 13 is a wireframe of an example of a vertically oriented month view user interface showing a day view” list of appointments in a calendar management software application further which is executing instructions according to embodiments disclosed in this paper. The day view is shown in element 1305. As discussed elsewhere in this paper, the day view may be invoked by a long tap, spread, or other single or multi-finger gesture on (or proximate to) element 1300. The day view may also be invoked from a 2×2 view. An alternative “day view” is shown as element 1900 in FIG. 19.

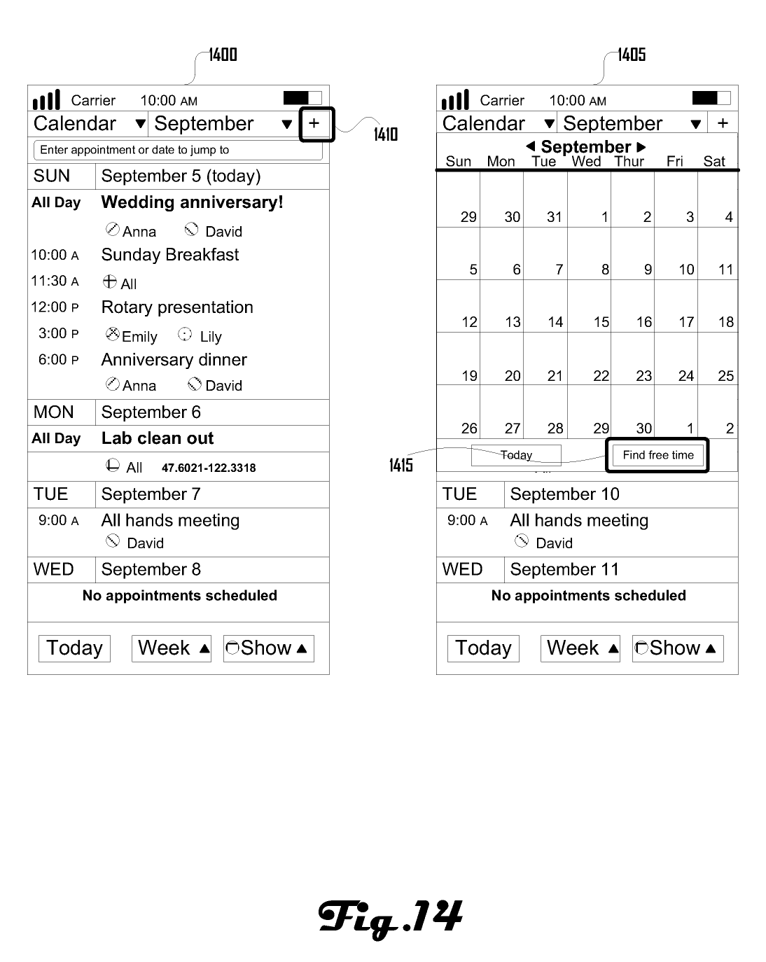

FIG. 14 is a wireframe of an example of a “week view” user interface showing activation of a “Find free time” function in a calendar management software application which is executing instructions according to embodiments disclosed in this paper. In element 1400, the “Find free time” function has not yet been invoked. The “Find free time” function may be invoked by selecting element 1410 and/or by selecting a “Free” or similarly labeled command in a drop-down list. Invocation of the “Find free time” function may result in transitioning to the display shown in element 1405.

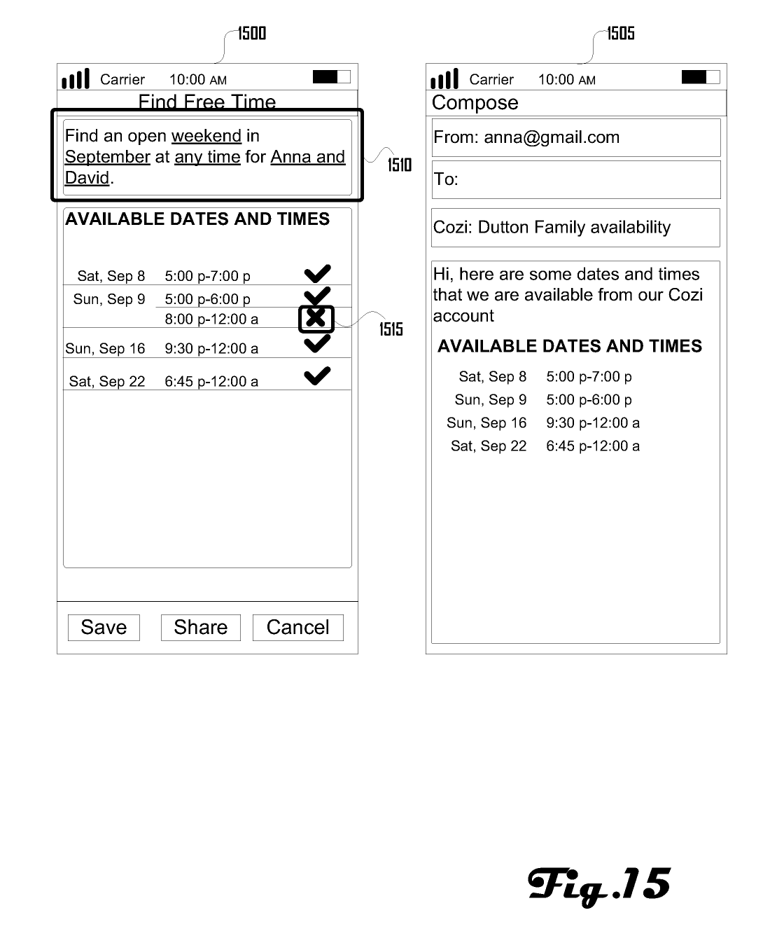

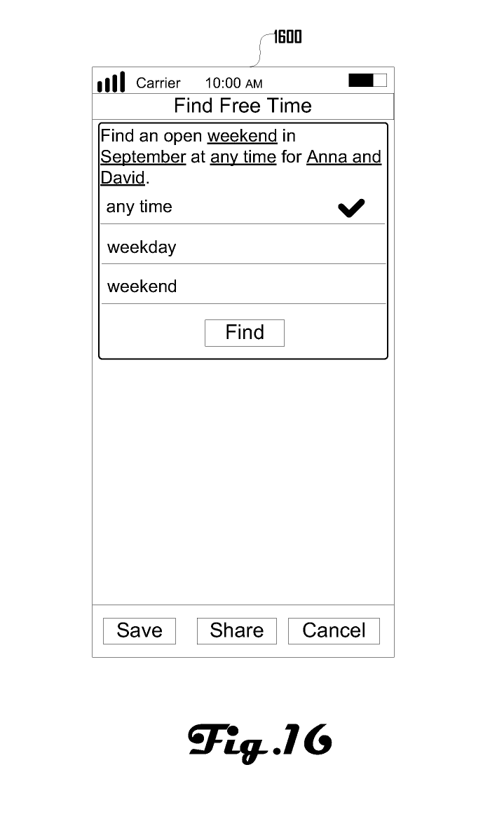

FIG. 15 is a wireframe of an example of “Find free time” and “Share free time” functions in a calendar management software application which is executing instructions according to embodiments disclosed in this paper. In element 1500, a “Find free time” function has been invoked, such as by selecting element 1415. Element 1510 shows search parameters which the user may select or adjust in the text which is underlined in element 1510 (selection of a parameter being accomplished by tapping the underlined text, discussed further below in relation to FIGS. 16, 17, and 18). The box below element 1510 shows the result of the selected search paramters. Element 1515 shows an “x” in relation to one of the results, which “x” was placed or created by a user (the check marks may have been similarly placed or created by the user). When the user selects “Share” in the graphical control elements on the bottom of the screen, the interface may change to 1505, which shows an interface allowing the user to send the list of free times to an email address, to another user of the system, to a social network, or similar. In the list of “Available Dates and Times” in element 1505, the row from element 1500 which had the “x” is not shown. This demonstrates that a user may select which free times to communicate to others.

FIG. 16 is a wireframe of an example of a “Find free time” function in a calendar management software application which is executing instructions according to embodiments disclosed in this paper. Element 1600 shows that the user has selected the underlined text “weekend” which has opened a sub-window showing alternatives including any time, weekday, and weekend. The user may tap one of the alternatives to create a check mark or “x” (in this example, showing creation of a check mark next to “any time”) and then the “Find” box to find open time at any time in September.

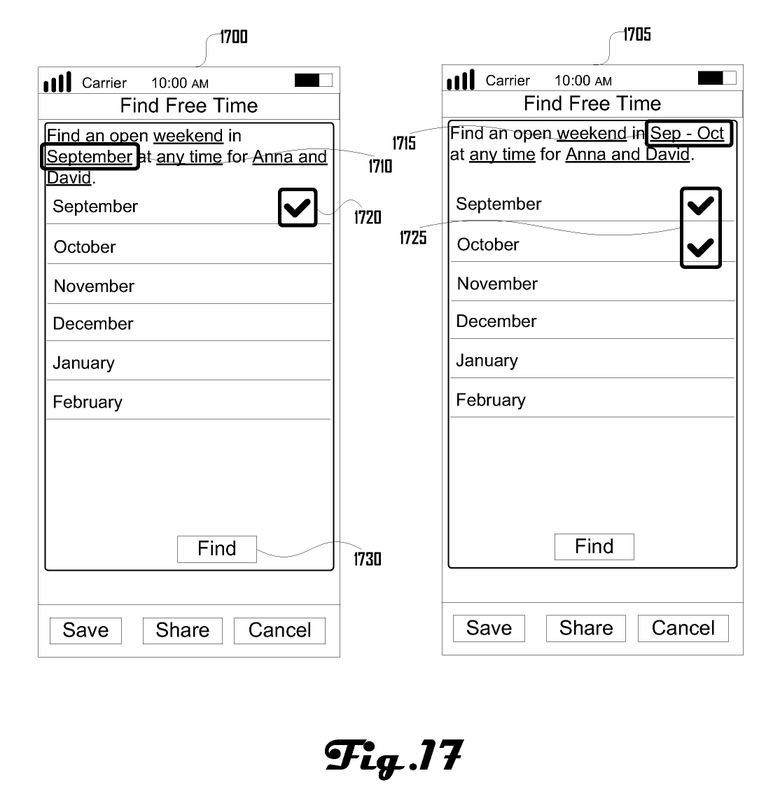

FIG. 17 is a wireframe of an example of a “Find free time” function in a calendar management software application which is executing instructions according to embodiments disclosed in this paper. Similar to above, this Figure shows that the month in which free time is searched for may be changed.

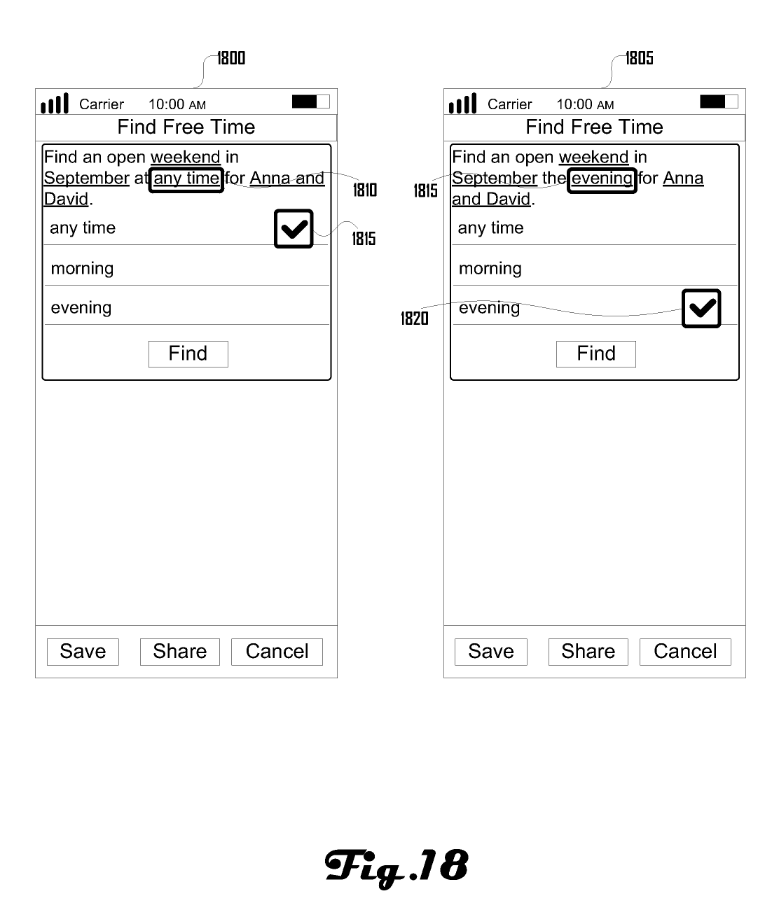

FIG. 18 is a wireframe of an example of a “Find free time” function in a calendar management software application which is executing instructions according to embodiments disclosed in this paper. Similar to above, this Figure shows that the time of day within the other search parameters may also be changed by the user.

FIG. 19 is a wireframe of an example of a “Collapse free time” function in a calendar management software application which is executing instructions according to embodiments disclosed in this paper. This Figure shows that free time is shown in a day view. Free time may be collapsed (or hidden) in this (or other) view by selecting graphical control element 1915, which may result in generation of the view shown in element 1920.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of displaying calendar data in a computer comprising a memory and a touchscreen display, the method comprising:
determining a first zoom level of a calendar interface in the display, wherein the calendar interface comprises grid of at least one column across at least one row;
determining a first starting display date;
selecting first components of the calendar according to the determined first zoom level and the first starting display date; and
rendering the selected components in the calendar interface at the determined zoom level and starting on the determined starting display date.

2. The method of claim 1, further comprising:
receiving an instruction to scroll within the calendar interface and, without changing the first zoom level, determining a second starting display date based on the scroll, selecting second components of the calendar according to the first zoom level and the second starting display date.

3. The method of claim 2, wherein the instruction to scroll is a swipe gesture on a touchscreen, which swipe gesture is one of left, right, up, and down.

4. The method of claim 2, wherein:
if the scroll is a scroll to the right, then determining the second starting display date to be the succeeding day relative to the first starting display date; and
if the scroll is to the left, then determining the second starting display date to be the preceding day relative to the first starting display date.

5. The method of claim 2, wherein if the zoom level is a month view and if the scroll is one swipe gesture to the right, then determining the second starting display date to be a Saturday and if the scroll is one swipe gesture to the left, then determining the second starting display date to be a Monday.

6. The method of claim 2, wherein rendering the selected components in the calendar interface at the determined zoom level and starting on the determined starting display date comprises rendering an animated transition between the first starting display date and the second starting display date.

7. The method of claim 1, wherein the grid comprises seven columns, one column for each day in a week, and five rows, one row for each successive week.

8. The method according to claim 1 wherein the first starting display date is a Saturday.

9. The method of claim 1, wherein the grid comprises two columns, each column for a day in a week, and two rows, one row for successive weeks.

10. The method of claim 1, wherein the grid comprises two columns, each column for a day in a week, and three rows, one row for successive weeks.

11. The method of claim 1, wherein the grid comprises one column for one day in a week and one row, which one row is sub-divided into sub-rows for each successive appointment in the day.

12. The method of claim 11, further comprising showing or hiding sub-rows for free hours within the day.

13. The method of claim 1, wherein the grid comprises one column and more than one row, one row for a day in a week, with each row sub-divided into sub-rows for each successive appointment in the day.

14. The method of claim 1, further comprising selecting a size of the selected components.

15. The method of claim 1, further comprising selecting a font for text in the selected components.

16. The method of claim 15, further comprising selecting a font size for rendering the selected components.

17. The method of claim 16 wherein the font size is determined by a number of components rendered in a sector within the grid within the calendar interface.

18. The method of claim 15, further comprising selecting a kerning or tracking of the font.

19. The method of claim 1, wherein the components comprise at least one of text, graphics, and color.

20. The method of claim 1, wherein the components comprise at least one of a day-of-week-text, a day-number, a month-text, a month-number, a time, an appointment text, a location, and a representation of a person.

21. The method of claim 20 wherein the time comprises at least one of a start time and an end time for an appointment.

22. The method of claim 20, wherein the representation of a person comprises a color.

23. The method of claim 20, wherein the representation of a person comprises a graphic.

24. The method of claim 23, wherein the graphic comprises at least one of an image, a photograph, and a shape.

25. The method of claim 19, further comprising selecting a leading of lines of the components.

26. The method of claim 1, wherein the zoom level is one of a year view, a month view, a 2×2 view, a week view, a day view, an appointment list view, and a single appointment view.

27. The method of claim 1, further comprising receiving an instruction to change the first zoom level to a second zoom level; determining a second starting display date; selecting components of the calendar based on the second zoom level and the second starting display date; and rendering the selected components in the calendar interface.

28. The method of claim 27 wherein the instruction to change the first zoom level is one of a one-finger gesture on the display, a two-finger gesture on the display, a long tap, a double tap, and a menu navigation.

29. The method of claim 27, wherein if the first zoom level is a month view and if the instruction to change the zoom level is a multi-finger gesture on a day within the month view or a double tap on a day within the month view, then selecting a 2×2 view and determining the second starting display date based on the day within the month view.

30. The method of claim 27, wherein the instruction to change the first zoom level invokes a week view.

31. The method of claim 27, wherein the instruction to change the zoom level invokes a popup comprising a list of appointments for a day.

32. The method of claim 1, further comprising receiving an instruction to change the first zoom level to a second zoom level and determining whether a user associated with the components of the calendar is authorized to access the second zoom level.

33. The method of claim 32, further comprising, if the user is determined not to be authorized to access the second zoom level, providing an offer to authorize the user to access the second zoom level, processing consideration for authorization to access the second zoom level, selecting a second starting display date; selecting components of the calendar based on the second zoom level and the second starting display date; and rendering the selected components in the calendar interface.

34. The method of claim 1, further comprising receiving an instruction from a first user associated with the components of the calendar to find free time within the components of the calendar, finding free time within the components of the calendar, and visually distinguishing the free time within the rendered selected components.

35. The method of claim 34, wherein the instruction to find free time within the components of the calendar comprises an instruction to find free time over a period of time for a second user associated with the components of the calendar.

36. The method of claim 34, further comprising receiving an instruction from the user to select a subset of the free time, receiving an instruction from the user to transmit the subset to a party, and transmitting calendar data to the party, which calendar data comprises the subset of free time found within the components of the calendar and selected by the user.

37. A computer system with a computer readable medium comprising instructions which, when executed, perform the method according to claim 1.
